(19) United States
(12) Patent Application Publication
(10) Pub. No.: US 2018/0089766 A1
(43) Pub. Date: Mar. 29, 2018

(54) CALCULATING DEVICE, CONTROL METHOD, AND RECORDING MEDIUM

(71) Applicant: CASIO COMPUTER CO., LTD., Tokyo (JP)

(72) Inventor: Hiroaki YOSHIZAWA, Tokyo (JP)

(73) Assignee: CASIO COMPUTER CO., LTD., , Tokyo (JP)

(21) Appl. No.: 15/684,019

(22) Filed: Aug. 23, 2017

(30) Foreign Application Priority Data
Sep. 23, 2016 (JP) 2016-185098

(51) Int. Cl. G06Q 40/00

(52) U.S. Cl. CPC G06Q 40/123

(57) ABSTRACT

A calculating device, includes: a display; and a processor, wherein, when numerical value data of tax-excluded amount data is input in accordance with a user operation, and a first operation for a tax calculation of a first tax rate is received, the processor calculates first tax-included amount data according to the first tax rate for the numerical value data, when numerical value data of tax-excluded amount data is input in accordance with the user operation, and a second operation for a tax calculation of a second tax rate is received, the processor calculates second tax-included amount data corresponding to the second tax rate for the numerical value data, when a third operation for a total tax calculation is received from a user, the processor causes total tax-included amount data to be displayed on the display, the total tax-included amount data being obtained by adding first subtotal tax-included amount data and second subtotal tax-included amount data obtained by adding at least one piece of the second tax-included amount data, wherein, the first subtotal tax-included amount data is a data that obtained by adding at least one piece of the calculated first tax-included amount data, and the second subtotal tax-included amount data is a data that obtained by adding at least one piece of the second tax-included amount data, and when a fourth operation for printing is received from the user after the total tax-included amount data is displayed on the display, the processor causes a printer to print subtotal tax-excluded amount data of the first tax rate corresponding to the first tax-included amount data and subtotal tax-excluded amount data of the second tax rate corresponding to the second tax-included amount data.

### TECHNICAL FIELD

The present invention relates to a calculating device, a control method, and a recording medium.

### BACKGROUND OF THE INVENTION

In the past, electronic devices (printer-equipped tax calculators) having a tax calculation function and a print function have been introduced (for example, JP 2005-104073 A).

Further, calculators which are capable of calculating tax using a plurality of tax rates have also been put into practical use.

### DESCRIPTION OF THE RELATED ART

Small calculating devices such as the printer-equipped tax calculators according to the related art are unable to make an appropriate response of classifying a tax calculation with a plurality of tax rates according to each tax and easily printing it.

### BRIEF SUMMARY OF THE INVENTION

The present invention was made in light of the above problems, and it is an advantage of the present invention to provide a calculation device, a calculation printing method, and a control program thereof which are capable of classifying a tax calculation with a plurality of tax rates according to each tax and easily printing it.

According to an embodiment of the present invention,

a display; and

a processor,

wherein, when numerical value data of tax-excluded amount data is input in accordance with a user operation, and a first operation for a tax calculation of a first tax rate is received, the processor calculates first tax-included amount data according to the first tax rate for the numerical value data,

when numerical value data of tax-excluded amount data is input in accordance with the user operation, and a second operation for a tax calculation of a second tax rate is received, the processor calculates second tax-included amount data corresponding to the second tax rate for the numerical value data,

when a third operation for a total tax calculation is received from a user, the processor causes total tax-included amount data to be displayed on the display, the total tax-included amount data being obtained by adding first subtotal tax-included amount data and second subtotal tax-included amount data obtained by adding at least one piece of the second tax-included amount data,

wherein, the first subtotal tax-included amount data is a data that obtained by adding at least one piece of the calculated first tax-included amount data, and the second subtotal tax-included amount data is a data that obtained by adding at least one piece of the second tax-included amount data, and

when a fourth operation for printing is received from the user after the total tax-included amount data is displayed on the display, the processor causes a printer to print subtotal tax-excluded amount data of the first tax rate corresponding to the first tax-included amount data and subtotal tax-excluded amount data of the second tax rate corresponding to the second tax-included amount data.

According to an embodiment of the present invention,

a method of controlling a calculating device, includes:

calculating, when numerical value data of tax-excluded amount data is input in accordance with a user operation, and an operation for a tax calculation of a first tax rate is received, first tax-included amount data according to the first tax rate for the numerical value data,

calculating, when numerical value data of tax-excluded amount data is input in accordance with the user operation, and an operation for a tax calculation of a second tax rate is received, second tax-included amount data corresponding to the second tax rate for the numerical value data,

causing total tax-included amount data to be displayed when an operation for a total tax calculation is received from a user, the total tax-included amount data being obtained by adding first subtotal tax-included amount data obtained by adding at least one piece of the calculated first tax-included amount data and second subtotal tax-included amount data obtained by adding at least one piece of the second tax-included amount data, and

causing, when an operation for printing is received from the user after the total tax-included amount data is displayed, a printer to print subtotal tax-excluded amount data of the first tax rate corresponding to the first tax-included amount data and subtotal tax-excluded amount data of the second tax rate corresponding to the second tax-included amount data.

According to an embodiment of the present invention,

calculating, when numerical value data of tax-excluded amount data is input in accordance with a user operation, and an operation for a tax calculation of a first tax rate is received, first tax-included amount data according to the first tax rate for the numerical value data,

calculating, when numerical value data of tax-excluded amount data is input in accordance with the user operation, and an operation for a tax calculation of a second tax rate is received, second tax-included amount data corresponding to the second tax rate for the numerical value data,

causing total tax-included amount data to be displayed when an operation for a total tax calculation is received from a user, the total tax-included amount data being obtained by adding first subtotal tax-included amount data obtained by adding at least one piece of the calculated first tax-included amount data and second subtotal tax-included amount data obtained by adding at least one piece of the second tax-included amount data, and

causing, when an operation for printing is received from the user after the total tax-included amount data is displayed, a printer to print subtotal tax-excluded amount data of the first tax rate corresponding to the first tax-included amount data and subtotal tax-excluded amount data of the second tax rate corresponding to the second tax-included amount data.

### BRIEF DESCRIPTION OF THE SEVERAL VIEWS OF THE DRAWING

FIG. 1 is a front view showing an external appearance configuration of a printer-equipped calculator 10 according to an embodiment of a calculating device of the present invention;

FIG. 2 is a block diagram illustrating a configuration of an electronic circuit of the printer-equipped calculator 10;

FIG. 3 is a diagram illustrating a specific example of calculation operation data registered in a calculation data memory 22c of the printer-equipped calculator 10;

FIG. 4 is a diagram illustrating a specific example of tax calculation data registered in a tax calculation data memory 22e of the printer-equipped calculator 10;

FIG. 5 is a flowchart illustrating a calculation data printing process (1) of the printer-equipped calculator 10;

FIG. 6 is a flowchart illustrating a calculation data printing process (2) of the printer-equipped calculator 10;

FIG. 7 is a flowchart illustrating a calculation data printing process (3) of the printer-equipped calculator 10;

FIG. 8 is a flowchart illustrating a registered data printing process (1) in the calculation data printing process of the printer-equipped calculator 10;

FIG. 9 is a flowchart illustrating a registered data printing process (2) in the calculation data printing process of the printer-equipped calculator 10;

FIG. 10 is a diagram illustrating a display/printing operation (1) according to a user operation of a first embodiment of the calculation data printing process;

FIG. 11 is a diagram illustrating a display/printing operation (2) according to the user operation of the first embodiment of the calculation data printing process; and

FIG. 12 is a diagram illustrating a display/printing operation according to a user operation of a second embodiment of the calculation data printing process.

### DETAILED DESCRIPTION OF THE INVENTION

Hereinafter, exemplary embodiments of the present invention will be described with reference to the accompanying drawings.

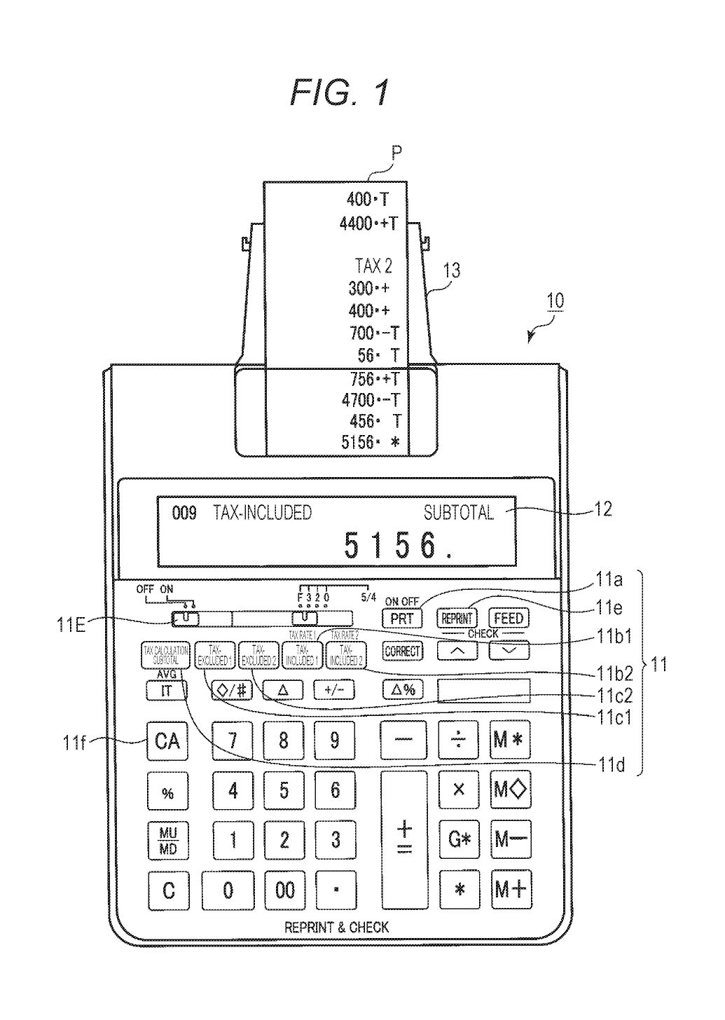

FIG. 1 is a front view illustrating an external appearance configuration of a printer-equipped calculator 10 according to an embodiment of a calculating device of the present invention.

The printer-equipped calculator 10 may be configured as a personal computer having a calculation function and a print function (in which a calculation data printing process program is installed), a tablet computer, a smartphone, a cellular phone, a touch panel type personal digital assistants (PDA), an electronic book, a portable game machine, and the like in addition to a calculation-dedicated calculator 10.

Further, a calculating device having no physical key (button) unlike the calculator 10 displays software keyboard similar to keys of the calculator 10 and performs a calculation process in accordance with a key operation performed on the software keyboard. Further, a calculating device having no a printer unlike the printer-equipped calculator 10 is connected with an external printer through near field communication or the like, transmits a print control signal and print data to the printer, and performs a printing process.

The printer-equipped calculator 10 according to the present embodiment includes a tax calculation function of performing a tax calculation based on a plurality of tax rates which are set in advance on numerical value data input in accordance with a user operation, a display function for displaying calculation data obtained by performing the tax calculation through the tax calculation function, and a print function of printing the calculation data of the tax calculation in addition to a normal calculation function such as addition, subtraction, multiplication, and division, a display function, a print function.

The printer-equipped calculator 10 includes a key input unit 11 and includes a display unit 12 and a printing unit 13 which are disposed on a back side of the key input unit 11.

The key input unit 11 includes a power key 11E, numeric keys, operation keys, a tax calculation function key, a print function key, and other function keys.

The numeric keys include a plurality of keys corresponding to, for example, [00] and [0] to [9]. The operation keys include a plurality of keys corresponding to, for example, a [+=] (addition) key, a [−] (subtraction) key, a [×] (multiplication) key, and a [+] (division) key. Further, when the [+=] (addition) key is input, subtotal calculation data obtained by adding up to a numerical value input just before the [+=] key is obtained.

The tax calculation function key includes a plurality of keys corresponding to a [tax-included 1] (tax-included 1 calculation) key 11b1 of a tax rate 1 (for example, 10%), a [tax-included 2] (tax-included 2 calculation) key 11b2 of a tax rate 2 (for example, 8%), a [tax-excluded 1] (tax-excluded 1 calculation) key 11c1 of the tax rate 1, a [tax-excluded 2] (tax-excluded 2 calculation) key 11c2 of the tax rate 2, and a [subtotal tax calculation] (total tax calculation) key 11d.

Further, operation data of the tax calculations corresponding to the [tax-included 1] key 11b1, the [tax-included 2] key 11b2, the [tax-excluded 1] key 11c1, the [tax-excluded 2] key 11c2, and the [subtotal tax calculation] key 11d are assumed to be tax-included 1 data [TAX1+], tax-included 2 data [TAX2+], tax-excluded 1 data [TAX1−], tax-excluded 2 data [TAX2-], total tax data [TAX TOTAL].

The print function key includes a plurality of keys corresponding to a [PRT] (print mode) key 11a and a [REPRINT] (registered data print) key 11e.

The other functions include, for example, a clear all key ([CA] key 11f), clear key ([C] key), and the like.

The display unit 12 includes a dot matrix type liquid crystal display (LCD) unit. A numerical value inputted by an operation performed on the keys of the key input unit 11 is displayed on the display unit 12. A numerical value corresponding to a limited number of rows (for example, one row) is displayed on the display unit 12. Further, a number, a character, and a symbol indicating various states such as a line number of calculation operation data, content of numerical value data being displayed, and operation mode being set are displayed on a state display area disposed along the side of the display unit 12.

The printing unit 13 includes, for example, a thermal transfer type printing mechanism and prints and outputs input numerical value data, a result of performing a calculation on calculation operation data including a tax calculation, and the like on a recording sheet P on the basis of a setting state of a print mode ON/OFF according to an operation of the [PRT] key 11a and an input state of the [REPRINT] key 11e.

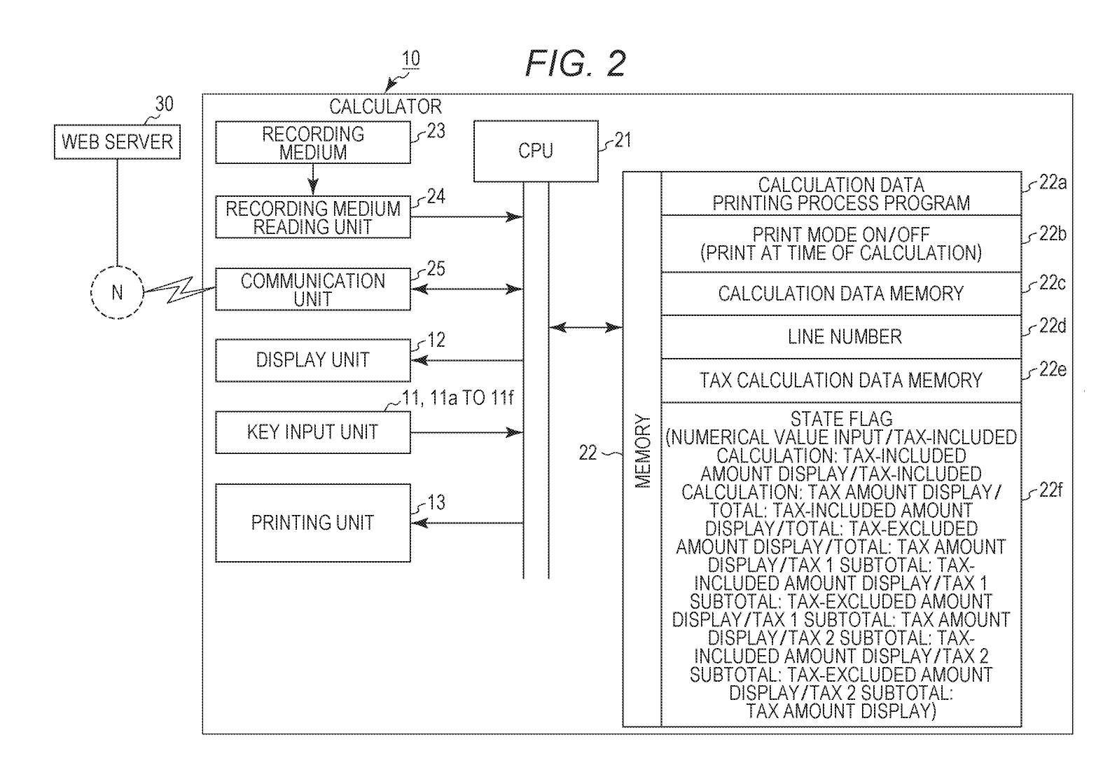

FIG. 2 is a block diagram illustrating a configuration of an electronic circuit of the printer-equipped calculator 10.

The electronic circuit of the printer-equipped calculator 10 includes a CPU (processor) 21 serving as a computer. The CPU 21 controls operations of circuit components in accordance with a calculator control program stored in a memory 22 and executes various kinds of calculation functions according to the user operation performed on the key input unit 11 and a print function of printing calculation data.

In addition to the key input unit 11, the display unit 12, the printing unit 13, and the memory 22, a recording medium reading unit 24 that reads data recorded in an external recording medium 23 such as a memory card and a communication unit 25 that performs communication with an external device 30 are connected to the CPU (processor) 21.

The calculator control program is stored in the memory 22 in advance, or read from the external recording medium 23 through the recording medium reading unit 24 and stored in the memory 22, or downloaded from a web server (a program server) 30 on a communication network N through the communication unit 25 and stored in the memory 22.

As the calculator control program, in addition to various kinds of calculation process (including a tax calculation process) programs according to the user operation, a calculation data printing process program 22a for printing calculation data of the calculation process executed in accordance with the calculation process program is included.

A PRINT mode memory 22b, a calculation data memory 22c, a line number memory 22d, a tax calculation data memory 22e, a state flag memory 22f, and the like are secured in the memory 22.

In the PRINT mode memory 22b, setting data of the print mode ON is stored at an initial setting when the calculator 10 is powered on, and thereafter, setting data of the print mode OFF and the setting data of the print mode ON are switched and stored each time the [PRT] (print mode) key 11a is operated. In the state of the print mode ON, printing is performed each time an input of the calculation operation data input is decided.

In the calculation data memory 22c, a series of calculation operation data including numerical value data input in accordance with the user operation and operation data of the tax calculation performed by the user are stored in association with a line number which sequentially increases and registered (a registration mode).

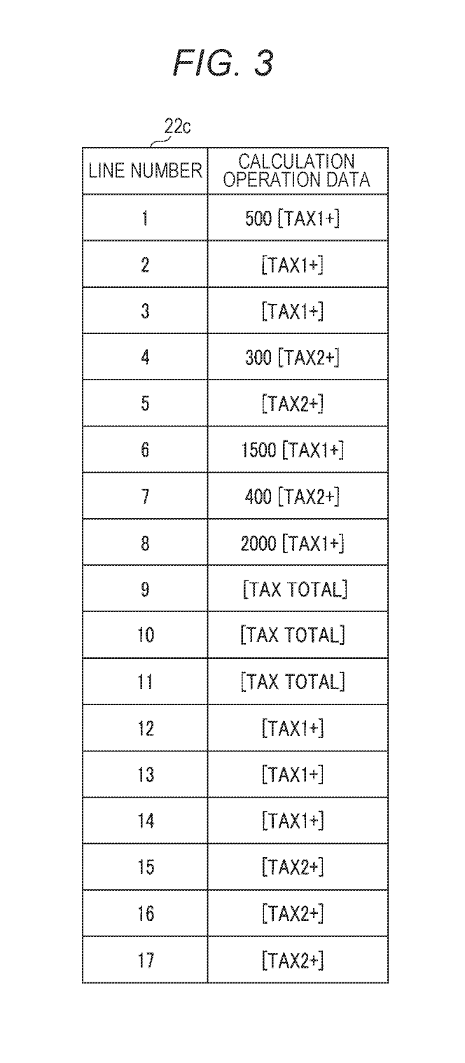

FIG. 3 is a diagram illustrating a specific example of the calculation operation data registered in the calculation data memory 22c of the printer-equipped calculator 10.

The line number memory 22d stores data of a line number of a processing target of the calculation data memory 22c in each mode of the registration mode and a reprint mode (a registered data print mode) in accordance with the operation of the [REPRINT] key 11e.

In the tax calculation data memory 22e, numerical value data (a tax-excluded amount or a tax-included amount) and tax rate data (the tax rate 1 or the tax rate 2) thereof are stored as the tax calculation data in accordance with a set of the numerical value data and the operation data of the tax calculation (the tax-included 1 data [TAX1+], the tax-included 2 data [TAX2+], the tax-excluded 1 data [TAX1−], or the tax-excluded 2 data [TAX2−]) among a series of calculation operation data registered in the calculation data memory 22c. Further, the tax calculation data memory 22e stores tax 1 subtotal tax-excluded amount data and tax 1 subtotal tax amount data at the tax rate 1 and tax 2 subtotal tax-excluded amount data and tax 2 subtotal tax amount data at the tax rate 2 which are calculated on the basis of the stored tax calculation data. Then, on the basis of this, tax 1 subtotal tax-included amount data, tax 2 subtotal tax-included amount data, total tax-excluded amount data, total tax amount data, and total tax-included amount data are also calculated.

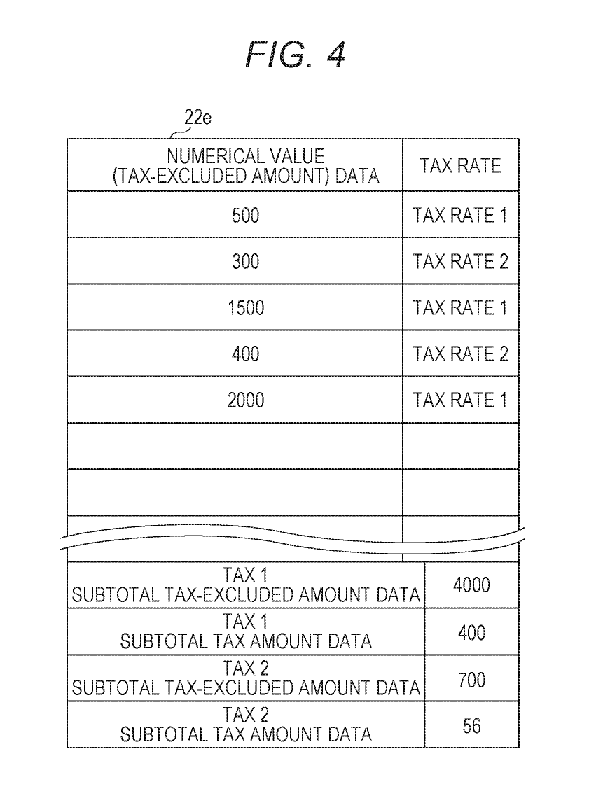

FIG. 4 is a diagram illustrating a specific example of the tax calculation data registered in the tax calculation data memory 22e of the printer-equipped calculator 10.

The state flag memory 22f stores a state flag indicating one of a [numerical value input state], which inputs the numerical value data, [tax-included amount display state of tax-included calculation], a [tax amount display state of tax-included calculation], a [tax-excluded amount display state of tax-excluded calculation], a [tax amount display state of tax-excluded calculation], a [total tax-included amount display state], a [total tax-excluded amount display state], a [total tax amount display state], a [tax 1 subtotal tax-included amount display state], a [tax 1 subtotal tax-excluded amount display state], a [tax 1 subtotal tax amount display state], a [tax 2 subtotal tax-included amount display state], a [tax 2 subtotal tax-excluded amount display state], and a [tax 2 subtotal tax amount display state] as the operation state of the calculator 10 according to the calculation data printing process (22a).

In the printer-equipped calculator 10 having the above configuration, the CPU 21 controls the operations of the circuit components in accordance with a command described in the calculator control program (the calculation data printing process program 22a) such that software and hardware perform an operation in cooperation with each other, and thus various kinds of tax calculation functions and the print functions of printing the calculation data are implemented as will described in the following operation description.

Next, an operation of the printer-equipped calculator 10 having the above configuration will be described.

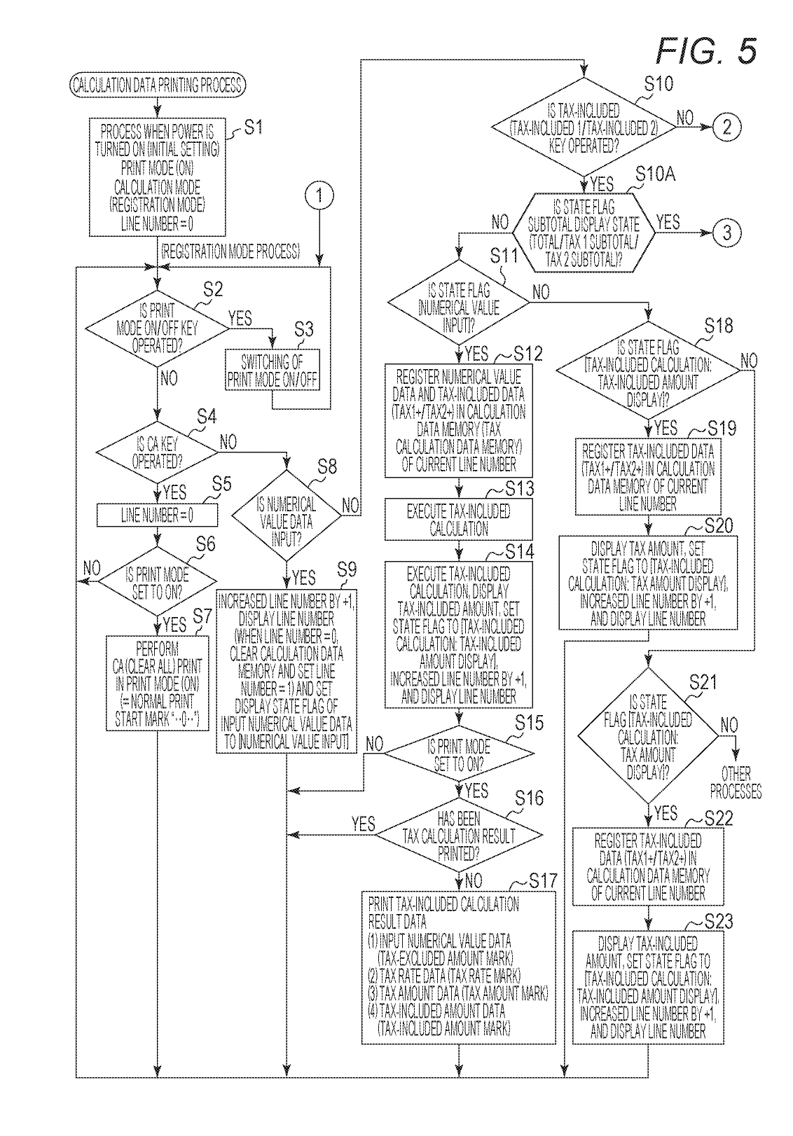

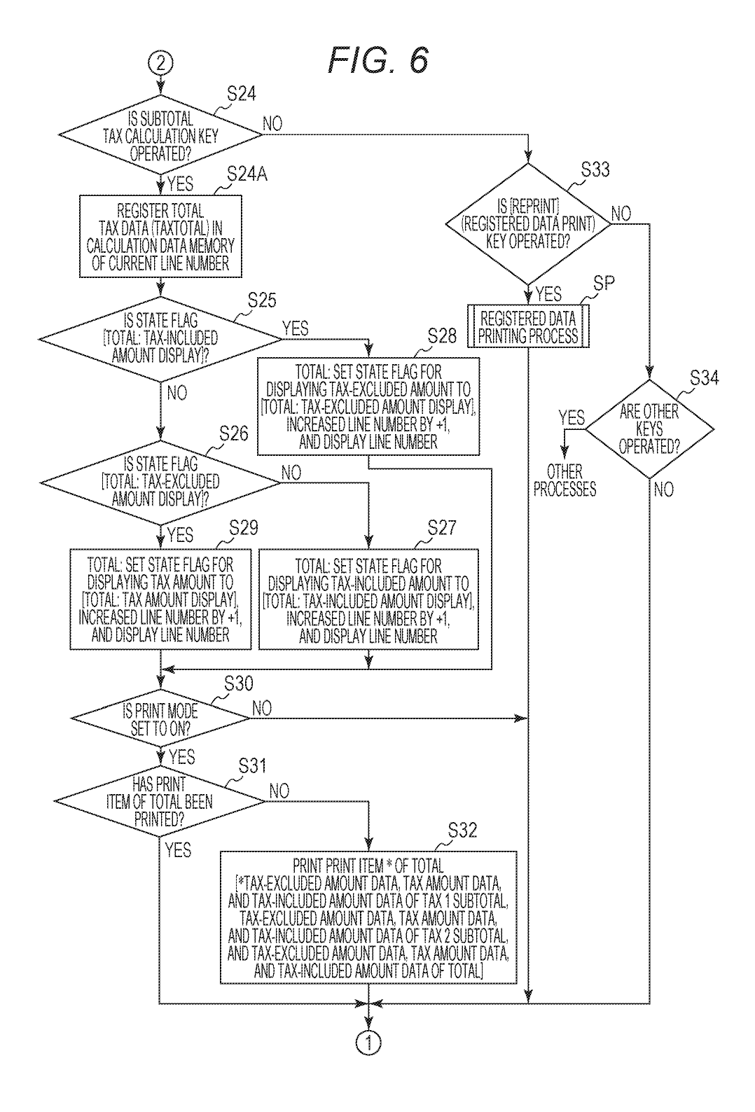

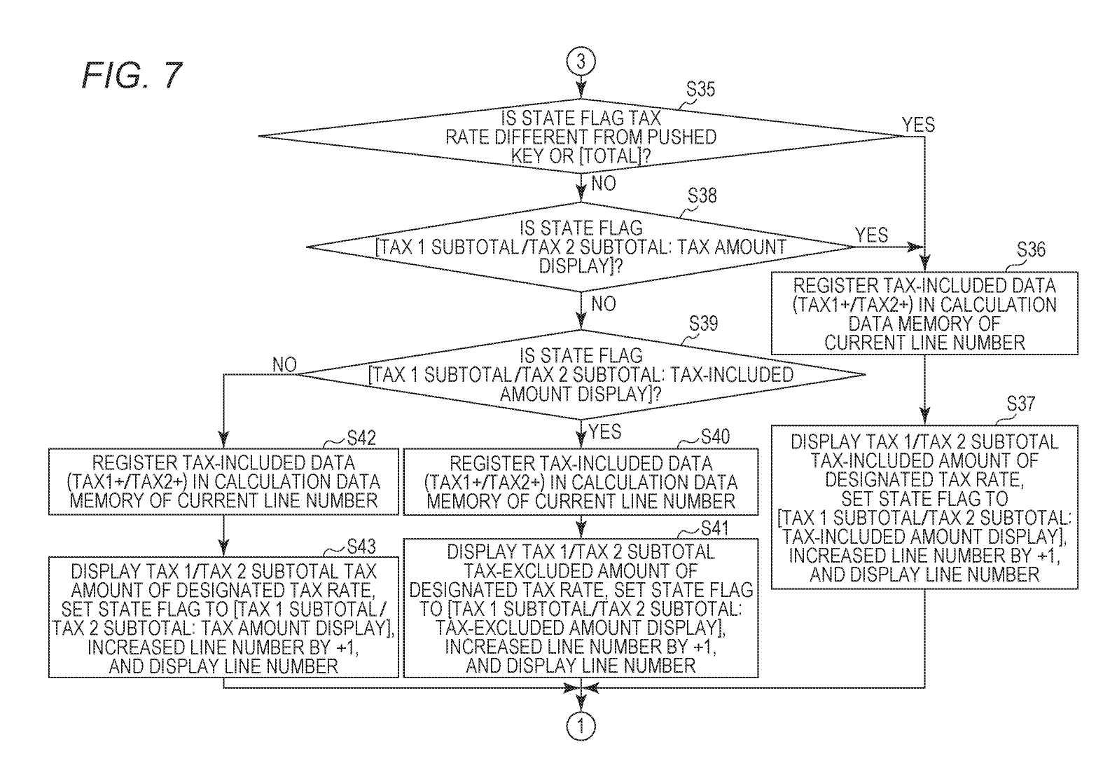

FIGS. 5, 6, and 7 are flowcharts illustrating calculation data printing processes (1, 2, and 3) of the printer-equipped calculator 10.

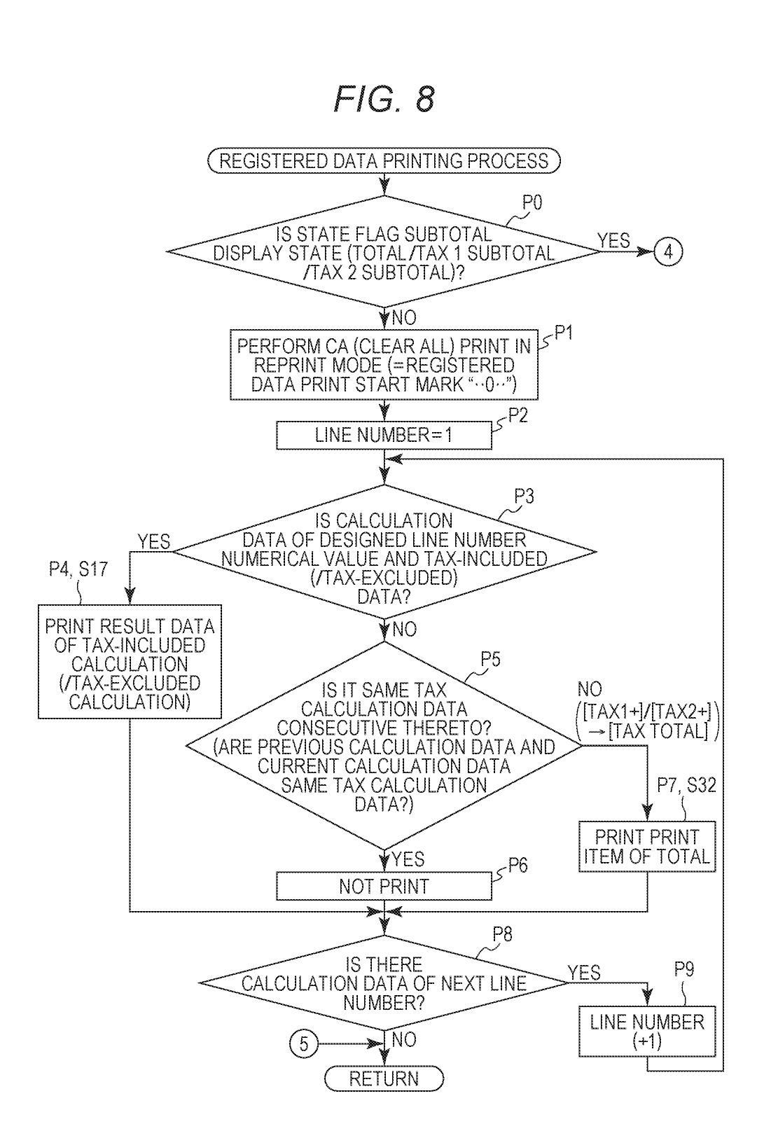

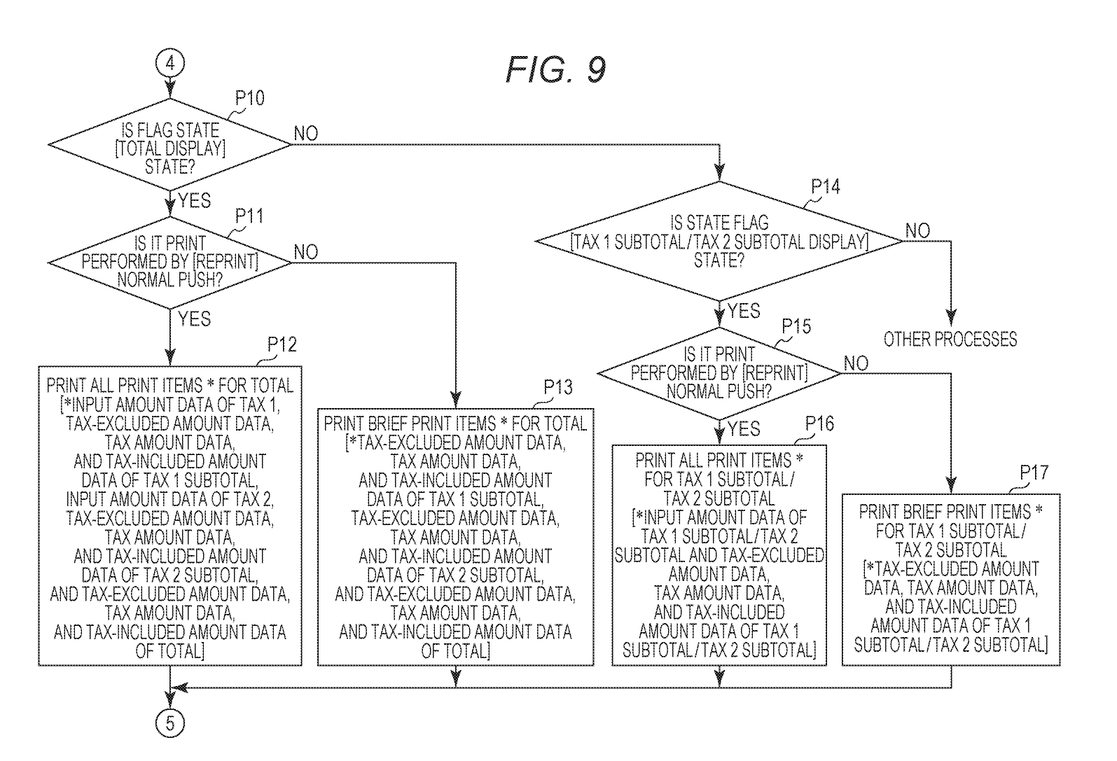

FIGS. 8 and 9 are flowcharts illustrating registered data printing processes (1 and 2) in the calculation data printing process of the printer-equipped calculator 10.

In this operation description, it is assumed that a liquor A (500 yen), a cloth A (1500 yen), and a cloth B (2000 yen) which are normal taxable items (the tax rate 1: 10%) and a food item A (300 yen) and a food item B (400 yen) which are reduced taxable items (the tax rate 2: 8%) are sold in a store, a tax calculation is performed, an invoice is created.

### First Embodiment

In a first embodiment, an operation in a state in which the setting data of the print mode OFF is stored in the PRINT mode memory 22b will be described.

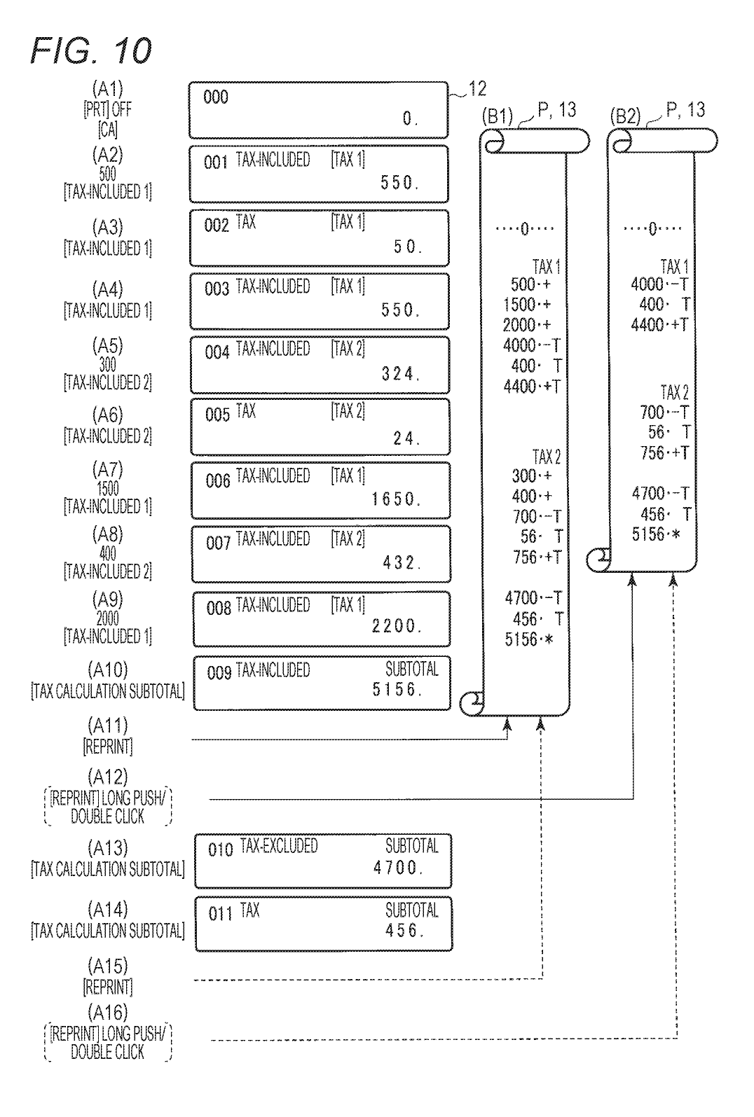

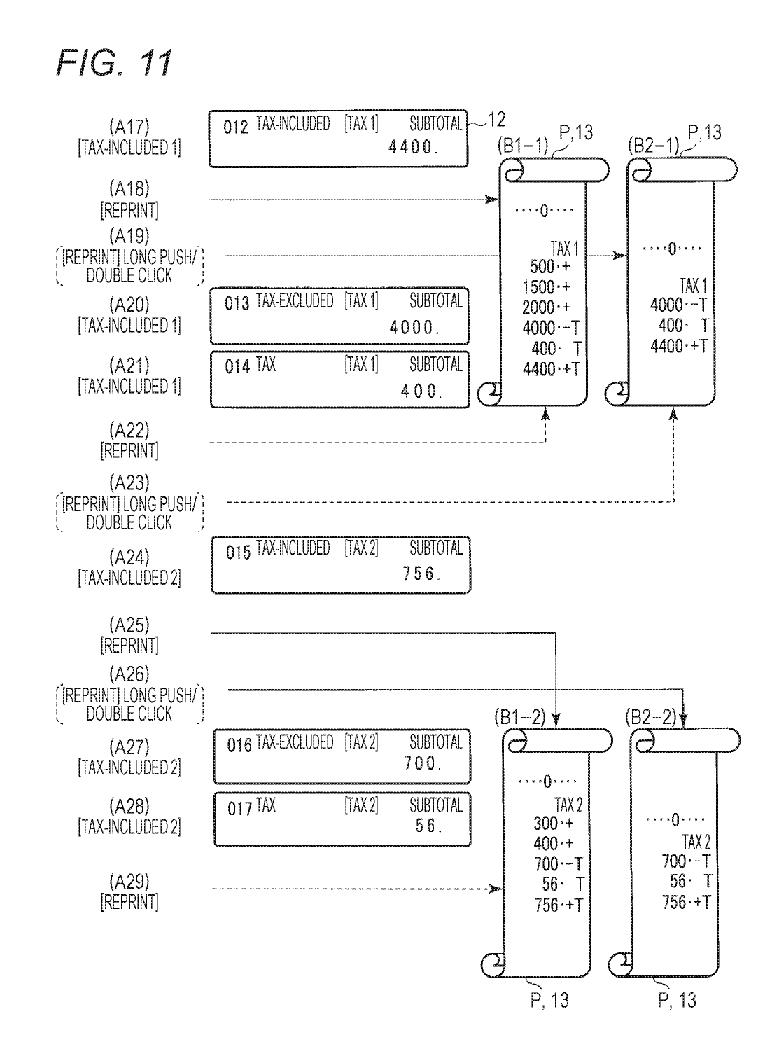

FIGS. 10 and 11 are diagrams illustrating display/printing operations (1 and 2) according to the user operation of the first embodiment of the calculation data printing process.

In the printer-equipped calculator 10, when the power is turned on in accordance with the user operation, as an initial setting process according to the power ON, the CPU 21 causes the setting data of the print mode (ON) to be stored in the PRINT mode memory 22b, sets the calculation mode to the registration mode, and stores data of a line number “0” in the line number memory 22d (step S1).

When the [PRT] (print mode) key 11a is operated in the state of the print mode (ON) (step S2 (Yes)), the setting data of the print mode (ON) is switched to the setting data of the print mode (OFF) (step S3).

Then, when the [CA] key 11f is operated as illustrated in FIG. 10 (A1) (step S4 (Yes)), the data of the line number is set to “0” again (step S5).

Here, since the print mode (OFF) is set (step S6 (No)), the print start process in the print mode (ON) in step S7 is not performed.

Then, when a price (tax-excluded amount) “500” of the liquor A which is the normal taxable item (the tax rate 1: 10%) is input in accordance with the user operation on the numeric key as illustrated in FIG. 10 (A2) (step S8 (Yes)), the data of the line number is increased by +1, updated to “1,” and displayed on the display unit 12. Further, the inputted numerical value data “500” is displayed on the display unit 12. Then, the state flag of the state flag memory 22f is set to the [numerical value input state] (step S9).

Here, when the [tax-included 1] (tax-included 1 calculation) key 11b1 is operated (step S10 (Yes)), it is determined whether or not the state flag of the state flag memory 22f is any one subtotal display state of the [total . . . display state], the [tax 1 subtotal . . . display state]] and the [tax 2 subtotal . . . display state] (step S10A), and when the state flag of the state flag memory 22f is not the subtotal display state (step S10A(No)), the flag state is determined to be the [numerical value input state] (step S11).

When the state flag is determined to be the [numerical value input state] (step S11 (Yes)), the input numerical value data “500” and the tax-included 1 data [TAX1+] corresponding to the [tax-included 1] (tax-included 1 calculation) key 11b1 are stored and registered in an area of the line number “1” of the calculation data memory 22c (see FIG. 3) in accordance with the current line number data “1” stored in the line number memory 22d. Accordingly, the input numerical value data “500” and the tax rate data (the tax rate 1: 10%) corresponding to the [tax-included 1] (tax-included 1 calculation) key 11b1 are stored and registered in the tax calculation data memory 22e (see FIG. 4) (step S12).

Then, the tax-included 1 calculation (the tax rate 1: 10%) for the numerical value data “500” is executed (step S13). Further, the tax-included amount data “550” obtained by performing the tax-included 1 calculation is displayed, and a symbol “tax-included [tax 1]” indicating the tax-included amount is displayed. Further, the state flag of the state flag memory 22f is set to the [tax-included amount display state of the tax-included calculation]. Then, the line number data “1” is increased by +1, updated to “2,” and displayed (step S14).

Here, since the print mode (OFF) is set here (step S15 (No)), the printing process of printing the tax-included calculation result in the print mode (ON) according to steps S16 and S17 is not performed.

Here, when the [tax-included 1] (tax-included 1 calculation) key 11b1 is operated once again as illustrated in FIG. 10 (A3) (step S10 (Yes)), the state flag of the state flag memory 22f is determined to be the [tax-included amount display state of the tax-included calculation] (step S18 (Yes)).

In this case, the tax-included 1 data [TAX1+] corresponding to the [tax-included 1] (tax-included 1 calculation) key 11b1 is stored and registered in an area of the line number “2” of the calculation data memory 22c (see FIG. 3) in accordance with the current line number data “2” stored in the line number memory 22d (step S19).

Then, the tax amount data “50” obtained by performing the tax-included 1 calculation is displayed, and a symbol “tax [tax 1]” indicating the tax amount is displayed. Further, the state flag of the state flag memory 22f is set to the [tax amount display state of the tax-included calculation]. Then, the line number data “2” is increased by +1, updated to “3,” and displayed (step S20).

Here, when the [tax-included 1] key 11b1 is operated once again as illustrated in FIG. 10 (A4) (step S10 (Yes)), the state flag is set to the [tax amount display state of the tax-included calculation] (step S21 (Yes)).

Then, the tax-included 1 data [TAX1+] corresponding to the [tax-included 1] key 11b1 is stored and registered in an area of the line number “3” of the calculation data memory 22c (see FIG. 3) in accordance with the current line number data “3” stored in the line number memory 22d (step S22).

Then, the tax-included amount data “550” obtained by performing the tax-included 1 calculation is displayed again, and a symbol “tax-included [tax 1]” indicating the tax-included amount is displayed. Further, the state flag of the state flag memory 22f is set to the [tax-included amount display state of the tax-included calculation] again. Then, the line number data “3” is increased by +1, updated to “4,” and displayed (step S23).

Then, when a price (tax-excluded amount) “300” of the food item A which is the reduced taxable item (the tax rate 2: 8%) is input in accordance with the user operation on the numeric key as illustrated in FIG. 10 (A5) (step S8 (Yes)), the input numerical value data “300” is displayed on the display unit 12. Further, the state flag of the state flag memory 22f is set to the [numerical value input state] (step S9).

When the [tax-included 2] (tax-included 2 calculation) key 11b2 is operated (step S10 (Yes)), the state flag of the state flag memory 22f is determined to be the [numerical value input state] (step S11 (Yes)), the input numerical value data “300” and the tax-included 2 data [TAX2+] corresponding to the [tax-included 2] (tax-included 2 calculation) key 11b2 are stored and registered in an area of line number “4” of the calculation data memory 22c (see FIG. 3) in accordance with the current line number data “4.” Accordingly, the input numerical value data “300” and the tax rate data (the tax rate 2: 8%) corresponding to the [tax-included 2] (tax-included 2 calculation) key 11b2 are stored and registered in the tax calculation data memory 22e (see FIG. 4) (step S12).

In this case, similarly, the tax-included 2 calculation (tax rate 2: 8%) for the numerical value data “300” is executed (step S13), the tax-included amount data “324” obtained by performing the tax-included 2 calculation is displayed, and a symbol “tax-included [tax 2]” indicating the tax-included amount is displayed. Further, the state flag of the state flag memory 22f is set to the [tax-included amount display state of the tax-included calculation]. Then, the line number data “4” is increased by +1, updated to “5,” and displayed (step S14).

Here, when the [tax-included 2] (tax-included 2 calculation) key 11b2 is operated once again as illustrated in FIG. 10 (A6) (step S10 (Yes)), the state flag of the state flag memory 22f is determined to be the [tax-included amount display state of the tax-included calculation] (step S18 (Yes)).

In this case, similarly, the tax-included 2 data [TAX2+] corresponding to the [tax-included 2] (tax-included 2 calculation) key 11b2 is stored and registered in an area of the line number “5” of the calculation data memory 22c (see FIG. 3) in accordance with the current line number data “5” stored in the line number memory 22d (step S19).

Then, the tax amount data “24” obtained by performing the tax-included 2 calculation is displayed, and a symbol “tax [tax 2]” indicating the tax amount is displayed. Further, the state flag of the state flag memory 22f is set to the [tax amount display state of the tax-included calculation]. Then, the line number data “5” is increased by +1, updated to “6,” and displayed (step S20).

Thereafter, similarly, when a price (tax-excluded amount) “1500” of the clothing A which is the normal taxable item (the tax rate 1: 10%) is input as illustrated in FIG. 10 (A7), and the [tax-included 1] (tax-included 1 calculation) key 11b1 is operated, the input numerical value data “1500” and the tax-included 1 data [TAX1+] are stored and registered in an area of the line number “6” of the calculation data memory 22c (see FIG. 3) in accordance with the current line number data “6.” Accordingly, the input numerical value data “1500” and the tax rate data (the tax rate 1: 10%) corresponding to the [tax-included 1] (tax-included 1 calculation) key 11b1 are stored and registered in the tax calculation data memory 22e (see FIG. 4) (steps S8 to S12).

Then, the tax-included 1 calculation (tax rate 1: 10%) for the numerical value data “1500” is executed (step S13), the tax-included amount data “1650” obtained by performing the tax-included 1 calculation is displayed, and a symbol “tax-included [tax 1]” indicating the tax-included amount is displayed. Then, the line number data “6” is increased by +1, updated to “7,” and displayed (step S14).

Thereafter, when a price (tax-excluded amount) “400” of the food item B which is the reduced taxable item (the tax rate 2: 8%) is input as illustrated in FIG. 10 (A8), and the [tax-included 2] (tax-included 2 calculation) key 11b2 is operated, the input numerical value data “400” and tax-included 2 data [TAX2+] are stored and registered in an area of the line number “7” of the calculation data memory 22c (see FIG. 3). Accordingly, the input numerical value data “400” and the tax rate data (the tax rate 2: 8%) are stored and registered in the tax calculation data memory 22e (see FIG. 4) (steps S8 to S12).

Then, the tax-included 2 calculation (the tax rate 2: 8%) for the numerical value data “400” is executed (step S13), and the tax-included amount data “432” obtained by performing the tax-included 2 calculation is displayed. Then, the line number data “7” is increased by +1, updated to “8,” and displayed (step S14).

Further, when a price (tax-excluded amount) “2000” of the clothing B which is the normal taxable item (the tax rate 1: 10%) is input as illustrated in FIG. 10 (A9), and the [tax-included 1] (tax-included 1 calculation) key 11b1 is operated, the input numerical value data “2000” and the tax-included 1 data [TAX1+] are stored and registered in an area of the line number “8” of the calculation data memory 22c (see FIG. 3). Accordingly, the input numerical value data “2000” and the tax rate data (the tax rate 1: 10%) are stored and registered in the tax calculation data memory 22e (see FIG. 4) (steps S8 to S12).

Then, the tax-included 1 calculation (the tax rate 1: 10%) for the numerical value data “2000” is executed (step S13), and the tax-included amount data “2200” obtained by performing the tax-included 1 calculation is displayed. Then, the line number data “8” is increased by +1, updated to “9,” and displayed (step S14).

Here, when the [subtotal tax calculation] (total tax calculation) key 11d is operated in order to obtain a total amount for the items in which the tax calculation is performed with a plurality of tax rates as illustrated in FIG. 10 (A10) (step S24 (Yes)), input total tax data [TAX TOTAL] is stored and registered in an area of the current line number “9” of the calculation data memory 22c (see FIG. 3) (step S24A).

In this case, here, since the state flag of the state flag memory 22f is set to the [tax-included amount display state of the tax-included calculation], and the state flag of the state flag memory 22f is determined to be neither the [total tax-included amount display state] or the [total tax-excluded amount display state] (step S25 (No) and step S26 (No)).

In this case, total tax-included amount data “5156” is calculated and displayed in accordance with the calculation operation data (the calculation operation data of the line number “1,” “4,” “6,” “7,” and “8”) registered in the calculation data memory 22c as the numerical value data and the tax-included 1 data [TAX1+] and the numerical value data and the tax-included 2 data [TAX2+], and a symbol “tax-included [subtotal]” indicating the total tax-included amount is displayed. Further, the state flag of the state flag memory 22f is set to the [total tax-included amount display state]. Then, the line number data “9” is increased by +1, updated to “10,” and displayed (step S27).

Here, since the print mode (OFF) is set (step S30 (No)), the printing process of printing the total calculation result in the print mode (ON) according to steps S31 and S32 is not performed.

Then, when the [REPRINT] (registered data print) key 11e is normally operated (for example, one click operation) as illustrated in FIG. 10 (A11) (step S33 (Yes)), the registered data printing process illustrated in FIG. 8 and FIG. 9 is executed (step SP).

When the registered data printing process is started, the state flag of the state flag memory 22f is determined to be set to the [total tax-included amount display state] (step P0 (Yes)→step P10 (Yes)), and the [REPRINT] key 11e is determined to be normally operated (step P11 (Yes)).

In this case, all print items for the total [the input amount (tax-excluded amount) data “500·+,” “1500·+,” and “2000·+,” the tax 1 subtotal tax-excluded amount data “4000·−T,” the tax amount data “400·T,” and the tax-included amount data “4400·+T” of the tax 1, the input amount (tax-excluded amount) data “300·+,” “400·+,” the tax 2 subtotal tax-excluded amount data “700·−T,” the tax amount data “56·T,” and the tax-included amount data “756·+T” of the tax 2, and the tax-excluded amount data “4700·−T,” the tax amount data “456·T,” and the tax-included amount data “5156·*” of the total] are printed on the recording sheet P through the printing unit 13 with the symbols of the respective items in accordance with the calculation operation data (the calculation operation data of the line numbers “1,” “4,” “6,” “7,” and “8”) registered in the calculation data memory 22c as the numerical value data and the tax-included 1 data [TAX1+] and the numerical value data and the tax-included 2 data [TAX2+] as illustrated in FIG. 10 (B1) (step P12).

Further, when the [REPRINT] key 11e is determined to be specially operated (for example, a long press operation or a double click operation) as illustrated in FIG. 10 (A12) (step P11 (No)), brief print items for the total [the tax-excluded amount data “4000·−T,” the tax amount data “400·T,” and the tax-included amount data “4400·+T” of the tax 1 subtotal, the tax-excluded amount data “700·−T,” the tax amount data “56·T,” and the tax-included amount data “756·+T” of the tax 2 subtotal, and the tax-excluded amount data “4700·−T,” the tax amount data “456·T,” and the tax-included amount data “5156·*” of the total] are printed on the recording sheet P through the printing unit 13 with the symbols of the respective items as illustrated in FIG. 10 (B2) (step P13).

Then, when the state flag of the state flag memory 22f is set to the [total tax-included amount display state] as illustrated in FIG. 10 (A10) to (A12), if the [subtotal tax calculation] key 11d is operated again as illustrated in FIG. 10 (A13) (step S24 (Yes)), the input total tax data [TAX TOTAL] is stored and registered in an area of the current line number “10” of the calculation data memory 22c (see FIG. 3) (step S24A). Further, the total tax-excluded amount data “4700” is calculated and displayed in accordance with the calculation operation data (the calculation operation data of the line numbers “1,” “4,” “6,” “7,” and “8”) of the calculation data memory 22c, and a symbol “tax-excluded [subtotal]” indicating the total tax-excluded amount is displayed. Further, the state flag of the state flag memory 22f is set to the [total tax-excluded amount display state]. Then, the line number data “10” is increased by +1, updated to “11,” and displayed (step S25 (Yes)→step S27).

Further, when the state flag of the state flag memory 22f is set to the [total tax-excluded amount display state], if the subtotal tax calculation key 11d is operated again as illustrated in FIG. 10 (A14) (step S24 (Yes)), the input total tax data [TAX TOTAL] is similarly stored and registered in an area of the current line number “11” of the calculation data memory 22c (see FIG. 3) (step S24A). Further, the total tax amount data “456” is calculated and displayed in accordance with each piece of calculation operation data of the calculation data memory 22c, and a symbol “tax [subtotal]” indicating the total tax amount is displayed. Further, the state flag of the state flag memory 22f is set to the [total tax amount display state]. Then, the line number data “11” is increased by +1, updated to “12,” and displayed (step S26 (Yes)→step S29).

As described above, when the [REPRINT] key 11e is normally operated (step S33 (Yes)) in the state in which the state flag is set to the [total tax-excluded amount display state] or the [total tax amount display state] as illustrated in FIG. 10 (A15), all the print items for the total are printed on the recording sheet P through the printing unit 13 as illustrated in FIG. 10 (B1), (step P0 (Yes)→steps P10 to P12).

Similarly, even when the [REPRINT] key 11e is specially operated as illustrated in FIG. 10 (A16) (step S33 (Yes)), the total brief print items are printed on the recording sheet P through the printing unit 13 as illustrated in FIG. 10 (B2) (step P0 (Yes)→step P10 (Yes), step P11 (No), and step P13).

Then, when the [tax-included 1] key 11b1 is operated as illustrated in FIG. 11 (A17) in the state in which the total tax-included amount data “5156,” the tax-excluded amount data “4700,” or the tax amount data “456” is displayed as illustrated in FIG. 10 (A10) to (A16) (step S10 (Yes)), the state flag is determined to be set to the [total . . . display state] (step S10A (Yes)→step S35 (Yes)), and the tax-included 1 data [TAX1+] corresponding to the [tax-included 1] key 11b1 is stored and registered in an area of the current line number “12” of the calculation data memory 22c (see FIG. 3) (step S36).

Then, the tax 1 subtotal tax-included amount data “4400” at the tax rate 1 corresponding to the [tax-included 1] key 11b1 is calculated and displayed, and a symbol “tax-included [tax 1] subtotal” indicating the tax 1 subtotal tax-included amount is displayed. Further, the state flag is set to the [tax 1 subtotal tax-included amount display state]. Then, the line number data “12” is increased by +1, updated to “13,” and displayed (step S37).

Here, when the [REPRINT] key 11e is normally operated as illustrated in FIG. 11 (A18), and the registered data printing process of FIGS. 8 and 9 is started (step S33 (Yes)→step SP), the state flag is determined to be set to the [tax 1 subtotal display state] (step P0 (Yes)→step P10 (No)→step P14 (Yes)), and the [REPRINT] key 11e is determined to be normally operated (step P15 (Yes)).

In this case, all print items for the tax 1 subtotal [the input amount (tax-excluded amount) data “500·+,” “1500·+,” and “2000·+” of the tax 1 and the tax-excluded amount data “4000·−T,” the tax amount data “400·T,” and the tax-included amount data “4400·+T” of the tax 1 subtotal] are printed on the recording sheet P through the printing unit 13 with the symbols of the respective items as illustrated in FIG. 11 (B1-1) in accordance with the calculation operation data (the calculation operation data of the line numbers “1,” “6,” and “8”) registered in the calculation data memory 22c as the numerical value data and the tax-included 1 data [TAX1+] (step P16).

Further, when the [REPRINT] key 11e is determined to be specially operated as illustrated in FIG. 11 (A19) (step P15 (No)), brief print items for the tax 1 subtotal [the tax-excluded amount data “4000·−T,” the tax amount data “400·T,” and the tax-included amount data “4400·+T” of the tax 1 subtotal] are printed on the recording sheet P through the printing unit 13 with the symbols of the respective items as illustrated in FIG. 11 (B2-1) (step P17).

Then, when the state flag is determined to be set to [tax 1 subtotal tax-included amount display state] as illustrated in FIG. 11 (A17) to (A19), if the [tax-included 1] key 11b1 is operated again as illustrated in FIG. 11 (A20) (step S10 (Yes) and step S10A (Yes)), the state flag is determined to be the [tax 1 subtotal tax-included amount display state] (step S38 (No) and step S39 (Yes)) other than the [tax 2 subtotal . . . display state] corresponding to a tax rate different from that of the [tax-included 1] key 11b1 which is currently operated or the [total . . . display state] (step S35 (No)).

In this case, the tax-included 1 data [TAX1+] corresponding to the [tax-included 1] key 11b1 is stored and registered in an area of the current line number “13” of the calculation data memory 22c (see FIG. 3) (step S40).

Then, the tax 1 subtotal tax-excluded amount data “4000” at the tax rate 1 corresponding to the [tax-included 1] key 11b1 is calculated and displayed, and a symbol “tax-excluded [tax 1] subtotal” indicating the tax 1 subtotal tax-excluded amount is displayed. Further, the state flag is set to the [tax 1 subtotal tax-excluded amount display state]. Then, the line number data “13” is increased by +1, updated to “14,” and displayed (step S41).

Further, when the [tax-included 1] key 11b1 is operated again as illustrated in FIG. 11 (A21) (step S10 (Yes) and step S10A (Yes)), the input tax-included 1 data [TAX1+] is similarly stored and registered in an area of the current line number “14” of the calculation data memory 22c (see FIG. 3) (step S35 (No), step S38 (No), and step S39 (No)→S42). Then, the tax 1 subtotal tax amount data “400” at the tax rate 1 corresponding to the [tax-included 1] key 11b1 is calculated and displayed, and a symbol “tax [tax 1] subtotal” indicating the tax 1 subtotal tax amount is displayed. Further, the state flag is set to the [tax 1 subtotal tax amount display state]. Then, the line number data “14” is increased by +1, updated to “15,” and displayed (step S43).

As described above, even when the [REPRINT] key 11e is normally operated in the state in which the state flag is set to the [tax 1 subtotal tax-excluded amount display state] or the [tax 1 subtotal tax amount display state] as illustrated in FIG. 11 (A22) (step S33 (Yes)), all print items for the tax 1 subtotal are printed on the recording sheet P through the printing unit 13 as illustrated in FIG. 11 (B1-1) (step P0 (Yes)→steps P14 to P16).

Similarly, even when the [REPRINT] key 11e is specially operated as illustrated in FIG. 11 (A23) (step S33 (Yes)), brief print items for the tax 1 subtotal are printed on the recording sheet P through the printing unit 13 as illustrated in FIG. 11 (B2-1) (step P0 (Yes)→step P14 (Yes), step P15 (No), and step P17).

Then, when the [tax-included 2] key 11b2 is operated as illustrated in FIG. 11 (A24) (step S10 (Yes)), the state flag is determined to be the [tax 1 subtotal . . . display state] corresponding to a tax rate different from that of the [tax-included 2] key 11b2 which is currently operated (step S10A (Yes)→step S35 (Yes)).

In this case, the tax-included 2 data [TAX2+] corresponding to the [tax-included 2] key 11b2 is stored and registered in an area of the current line number “15” of the calculation data memory 22c (see FIG. 3) (step S36).

Then, the tax 2 subtotal tax-included amount data “756” at the tax rate 2 corresponding to the [tax-included 2] key 11b2 is calculated and displayed, and a symbol “tax-included [tax 2] subtotal” indicating the tax 2 subtotal tax-included amount is displayed. Further, the state flag is set to the [tax 2 subtotal tax-included amount display state]. Then, the line number data “15” is increased by +1, updated to “16,” and displayed (step S37).

Here, when the [REPRINT] key 11e is normally operated as illustrated in FIG. 11 (A25), and the registered data printing process in FIGS. 8 and 9 is started (step S33 (Yes)→step SP), the state flag is determined to be set to the [tax 2 subtotal . . . display state] (step P0 (Yes)→step P10 (No)→step P14 (Yes)), and the [REPRINT] key 11e is determined to be normally operated (step P15 (Yes)).

In this case, all print items for the tax 2 subtotal [the input amount(tax-excluded amount) data “300·+” and “400·+” of the tax 2 and the tax-excluded amount data “700·−T,” the tax amount data “56·T,” and the tax-included amount data “756·+T” of the tax 2 subtotal] are printed on the recording sheet P through the printing unit 13 with the symbols of the respective items in accordance with the calculation operation data (the calculation operation data of the line numbers “4” and “7”) registered in the calculation data memory 22c as the numerical value data and the tax-included 2 data [TAX2+] as illustrated in FIG. 11 (B1-2) (step P16).

Further, when the [REPRINT] key 11e is determined to be specially operated as illustrated in FIG. 11 (A26) (step P15 (No)), brief print items for the tax 2 subtotal [the tax-excluded amount data “700·−T,” the tax amount data “56·T,” and the tax-included amount data “756·+T” of the tax 2 subtotal] are printed on the recording sheet P through the printing unit 13 with the symbols of the respective items as illustrated in FIG. 11 (B2-2) (step P17).

Then, when the state flag is set to the [tax 2 subtotal tax-included amount display state] as illustrated in FIG. 11 (A24) to (A26), if the [tax-included 2] key 11b1 is operated again as illustrated in FIG. 11 (A27) (step S10 (Yes) and step S10A (Yes)), the state flag is determined to be the [tax 2 subtotal tax-included amount display state] (step S38 (No) and step S39 (Yes)) other than the [tax 1 subtotal . . . display state] corresponding to a tax rate different from that of the [tax-included 2] key 11b2 which is currently operated and the [total . . . display state] (step S35 (No)).

In this case, the tax-included 2 data [TAX2+] corresponding to the [tax-included 2] key 11b2 is stored and registered in an area of the current line number “16” of the calculation data memory 22c (see FIG. 3) (step S40).

Then, the tax 2 subtotal tax-excluded amount data “700” at the tax rate 2 corresponding to the [tax-included 2] key 11b2 is calculated and displayed, and a symbol “tax-excluded [tax 2] subtotal” the tax 2 subtotal tax-excluded amount is displayed. Further, the state flag is set to the [tax 2 subtotal tax-excluded amount display state]. Then, the line number data “16” is increased by +1, updated to “17,” and displayed (step S41).

Further, when the [tax-included 2] key 11b2 is operated again as illustrated in FIG. 11 (A28) (step S10 (Yes) and step S10A (Yes)), the input tax-included 2 data [TAX2+] is similarly stored and registered in an area of the line number “17” of the calculation data memory 22c (see FIG. 3) (step S35 (No), step S38 (No), and step S39 (No)→step S42). Then, the tax 2 subtotal tax amount data “56” at the tax rate 2 corresponding to the [tax-included 2] key 11b2 is calculated and displayed, and a symbol “tax [tax 2] subtotal” indicating the tax 2 subtotal tax amount is displayed. Further, the state flag is set to the [tax 2 subtotal tax amount display state] (step S43).

As described above, even when the [REPRINT] key 11e is normally operated in the state in which the state flag is set to the [tax 2 subtotal tax-excluded amount display state] or the [tax 2 subtotal tax amount display state] as illustrated in FIG. 11 (A29) (step S33 (Yes)), all print items for the tax 2 subtotal are printed on the recording sheet P through the printing unit 13 as illustrated in FIG. 11 (B1-2) (step P0 (Yes)→steps P14 to P16).

Similarly, even when the [REPRINT] key 11e is specially operated (step S33 (Yes)), brief print items for the tax 2 subtotal are printed on the recording sheet P through the printing unit 13 as illustrated in FIG. 11 (B2-2) (step P0 (Yes)→step P14 (Yes), step P15 (No), and step P17).

### Second Embodiment

In a second embodiment, an operation in a state in which the setting data of the print mode ON is stored in the PRINT mode memory 22b will be described.

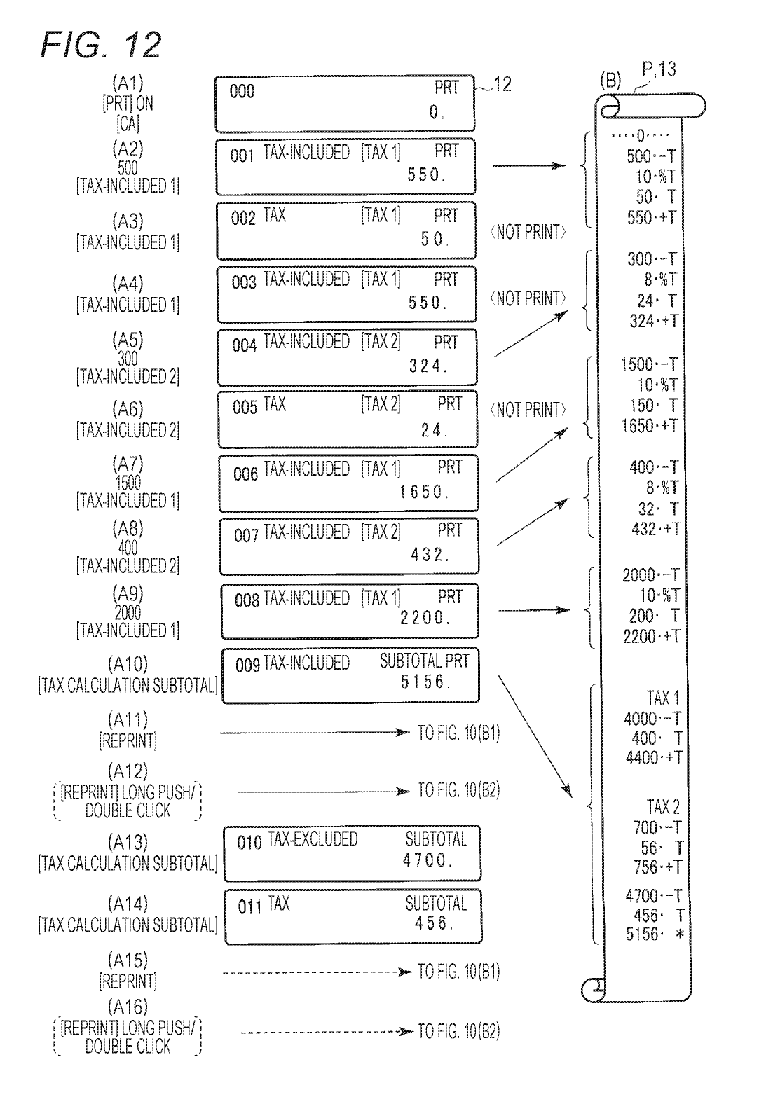

FIG. 12 is a diagram illustrating a display/printing operation according to a user operation of the second embodiment of the calculation data printing process.

In the printer-equipped calculator 10, when the [CA] key 11f is operated as illustrated in FIG. 12 (A1) (step S4 (Yes)) in the state of the print mode (ON) in which the setting data of the print mode (ON) is stored in the PRINT mode memory 22b (step S1), the data of the line number of the line number memory 22d is set to “0” (step S5). Numerical value data “0” and a symbol “PRT” indicating that it is the state of the print mode (ON) is displayed on the display unit 12.

Here, when the CPU 21 determines that it is the state of the print mode (ON) (step S6 (Yes)), as illustrated in FIG. 12 (B), a normal print start mark “ . . . 0 . . . ” indicating that it is printing according to the operation of the CA (Clear All) key 11f in the state of the print mode (ON) is printed on the recording sheet P through the printing unit 13 (step S7).

In the second embodiment, an input process, a calculation process, a display process, and a printing process according to the following user operations (1) to (4) are similar processes to those of the first embodiment except that it is the state in which the print mode (ON) is set, and thus detailed description thereof will be omitted.

(1) A process of operating the numeric key, the [tax-included 1] (tax 1 calculation) key 11b1, and the [tax-included 2] (tax 2 calculation) key 11b2, inputting the numerical value data of the tax-excluded amount of each of the normal taxable item and the reduced taxable item, and calculating and displaying the tax-included amount data (steps S8 to S14) or a process of repeatedly operating the [tax-included 1] key 11b1 or the [tax-included 2] key 11b2 and switching and displaying the tax amount data and the tax-included amount data of each of the normal taxable item and the reduced taxable item (steps S18 to S23) as illustrated in FIG. 12 (A2) to (A9) (similar to FIG. 10 (A2) to (A9) in the first embodiment).

(2) A process of operating the [subtotal tax calculation] (total tax calculation) key 11d and calculating and displaying the total tax-included amount data of the normal taxable item and the reduced taxable item (steps S24 to S27) or a process of repeatedly operating the [subtotal tax calculation] key 11d and switching and displaying the total tax-included amount data, the tax-excluded amount data, and the tax amount data (steps S24 to S29), a process of normally operating the [REPRINT] key 11e after the total tax-included amount data is calculating and printing all print items for the total (steps S33 and SP(P0 and P10 to P12)), or a process of specially operating the same [REPRINT] key 11e and printing brief print items for the total (steps S33 and SP(P0 and P10 to P13)) as illustrated in FIG. 12 (A10) to (A16) (similar to FIG. 10 (A10) to (A16), (B1) and (B2) in the first embodiment).

(3) Although not illustrated, a process of repeatedly operating the [tax-included 1] key 11b1 after the total tax-included amount data is calculated and switching and displaying the tax 1 subtotal tax-included amount data, the tax-excluded amount data, and the tax amount data (steps S10, S10A, and S35 to S43), a process of normally operating the [REPRINT] key 11e and printing all print items for the tax 1 subtotal (steps S33 and SP (P0 and P14 to P16)), or a process of specially operating the same [REPRINT] key 11e and printing brief print items for the tax 1 subtotal (steps S33 and SP (P0 and P14 to P17)) (similar to FIG. 11 (A17) to (A23), (B1-1) and (B2-1) in the first embodiment).

(4) Although not illustrated, a process of repeatedly operating the [tax-included 2] key 11b2 after the total tax-included amount data is calculated and switching and displaying the tax 2 subtotal tax-included amount data, the tax-excluded amount data, and the tax amount data (steps S10, S10A, and S35 to S43), a process of normally operating the [REPRINT] key 11e and printing all print items for the tax 2 subtotal (steps S33 and SP (P0 and P14 to P16)), or a process of specially operating the same [REPRINT] key 11e and printing brief print items for the tax 2 subtotal (steps S33 and SP (P0 and P14 to P17)) (similar to FIG. 11 (A24) to (A29), (B1-2) and (B2-2) in the first embodiment).

In other words, the second embodiment differs from the first embodiment in an operation in which, subsequently to the printing process of the normal print start mark “ . . . 0 . . . ” according to the operation of the [CA] key 11f in the state of the print mode(ON) as illustrated in FIGS. 12 (A1) and (B) (steps S4 to S7), the tax-included calculation is executed in accordance with an input of each pieces of numerical value data which is the tax-excluded amount of each of the normal taxable item and the reduced taxable item and the operation of the [tax-included 1] key 11b1 or the [tax-included 2] key 11b2 corresponding to each tax rate as illustrated in FIGS. 12 (A2), (A5), (A7), (A8), (A9), and (B), and the input numerical value data(tax-excluded amount) and the tax-excluded amount mark “−T,” the tax rate data and the tax rate mark “% T,” the tax amount data and the tax amount mark “T,” and the tax-included amount data and the tax-included amount mark “+T” are printed on the recording sheet P through the printing unit 13 as result data of the tax-included calculation (steps S15 to S17) each time each piece of tax-included amount data is displayed (steps S8 to S14).

Further, the second embodiment differs from the first embodiment in an operation in which, when the total tax-included amount data is calculated and displayed in accordance with the operation of the [subtotal tax calculation] key 11d as illustrated in FIGS. 12 (A10) and (B) (steps S24 to S27), the tax-excluded amount data and the tax-excluded amount mark “−T,” the tax amount data and the tax amount mark “T,” the tax-included amount data and the tax-included amount mark “+T,” the total tax-excluded amount data and the tax-excluded amount mark “−T,” the tax amount data and the tax amount mark “T,” and the tax-included amount data and the tax-included amount mark “*” which are obtained by a calculation according to each tax rate are printed on the recording sheet P through the printing unit 13 as result data of the total (steps S30 to S32).

For example, when the numerical value data (tax-excluded amount) “500” of the liquor A which is the normal taxable item is input, and the [tax-included 1] key 11b1 is operated as illustrated in FIG. 12 (A2), the tax-included amount data “550” of the input numerical value data (tax-excluded amount) is calculated and displayed (steps S8 to S14). In this case, as illustrated in FIG. 12 (B), subsequently to the normal print start mark “ . . . 0 . . . ,” the input numerical value data (tax-excluded amount data) “500·−T,” the tax rate data “10·% T,” the tax amount data “50·T,” and the tax-included amount data “550·+T” are printed on the recording sheet P (steps S15 to S17).

Further, as illustrated in FIG. 12 (A5), when the numerical value data (tax-excluded amount) “300” of the food item A which is the reduced taxable item is input, and the [tax-included 2] key 11b2 is operated, the tax-included amount data “324” of the input numerical value data (tax-excluded amount) is calculated and displayed (steps S8 to S14). Then, as illustrated in FIG. 12 (B), the input numerical value data (tax-excluded amount data) “300·−T,” the tax rate data “8·% T,” the tax amount data “24·T,” and the tax-included amount data “324·+T” are printed on the recording sheet P (steps S15 to S17).

Furthermore, as illustrated in FIG. 12 (A10), when the [subtotal tax calculation] key 11d is operated, total tax-included amount data “5156” is calculated and displayed on the basis of the calculation operation data including the numerical value data and the tax-included 1 data [TAX1+] or the tax-included 2 data [TAX2+] registered in the calculation data memory 22c (steps S24 to S27). In this case, as illustrated in FIG. 12 (B), the tax-excluded amount data “4000·−T,” the tax amount data “400·T,” and the tax-included amount data “4400·+T” of the tax 1 subtotal, the tax-excluded amount data “700·−T,” the tax amount data “56·T,” and the tax-included amount data “756·+T” of the tax 2 subtotal, and the tax-excluded amount data “4700·−T,” the tax amount data “456·T,” and the tax-included amount data “5156·*” of the total are printed on the recording sheet P (steps S30 to S32).

Further, when the tax-included amount data and the tax amount data of the tax rate 1 or the tax rate 2 are switched and displayed by the repetitive operation of the [tax-included 1] key 11b1 or the [tax-included 2] key 11b2 even in the state of the print mode (ON) as illustrated in FIG. 12 (A3), (A4), and (A6) (step S10 steps S18 to S23) or when the tax-included amount data, the tax-excluded amount data, and the tax amount data of the tax 1 subtotal or the tax 2 subtotal are switched and displayed by the operation of the [tax-included 1] key 11b1 or the [tax-included 2] key 11b2 after the operation of the [subtotal tax calculation] key 11d (steps S10 and S10A steps S35 to S43) (see FIG. 11 (A17), (A20), (A21), (A24), (A27), and (A28), individual printing of the tax-included amount data, the tax-excluded amount data, or the tax amount data is not performed, and thus unnecessary printing of data which is already printed is prevented.

Furthermore, when the total tax-included amount data, the tax-excluded amount data, and the tax amount data are switched and displayed by the repetitive operation of the [subtotal tax calculation] key 11d even in the state of the print mode (ON) as illustrated in FIGS. 12 (A10), (A13), and (A14) (steps S24 to S29), result data of the total only in accordance with a first operation of the [subtotal tax calculation] key 11d, and thereafter printing determined to have been completed is not performed (steps S30 to S32), and thus unnecessary printing of data which is already printed is here prevented as well.

When it returns to the line number data “0” and the numerical value data“0” displayed on the display unit 12 by the operation of the [CA] (Clear All) key 11f in the state in which a series of calculation operation data according to the tax calculation process is registered in the calculation data memory 22c (see FIG. 3) as a series of tax calculation processes according to the first embodiment or the second embodiment is executed, a series of calculation operation data registered in the calculation data memory 22c is not erased but held until a next key operation is performed.

Here, when the [REPRINT] (registered data print) key 11e is operated (step S33 (Yes)→step SP), printing similar to printing content in a series of tax calculation processes illustrated in FIG. 12 (B) is performed in accordance with the registered data printing process illustrated in FIG. 8 (steps P1 to P9).

In other words, when the registered data printing process is started, the state flag is determined not to be none of the [total . . . display state], the [tax 1 subtotal . . . display state], and the [tax 2 subtotal . . . display state] (step P0 (No)), a registered data print start mark “ . . . 0 . . . ” indicating that it is [CA] (clear all) printing in the reprint mode is printed on the recording sheet P through the printing unit 13 (step P1).

Then, the current line number data of the line number memory 22d is set to “1” (step P2), and it is determined whether or not the calculation operation data registered in the calculation data memory 22c in association with the current line number “1” is calculation data including the numerical value data and the tax-included (or tax-excluded) data (step P3).

Here, the calculation operation data registered in the calculation data memory 22c (see FIG. 3) in association with the current line number “1” is determined to be the calculation operation data including the numerical value data “500” and the tax-included 1 data [TAX1+] (step P3 (Yes)).

In this case, subsequently to the registered data print start mark “ . . . 0 . . . ” printed on the recording sheet P, the numerical value data (tax-excluded amount data) “500” and the tax-excluded amount mark “−T,” the tax rate data “10” and the tax rate mark “% T,” the tax amount data “50” and the tax amount mark “T,” and the tax-included amount data “550” and the tax-included amount mark “+T” are printed on the recording sheet P through the printing unit 13 as the tax calculation result data according to the numerical value data “500” and the tax-included 1 data [TAX+] (step P4 (similar to step S17)).

Thereafter, it is determined whether or not there is calculation operation data associated with a next line number in the calculation data memory 22c (see FIG. 3) (step P8). Here, it is determined that there is calculation operation data (tax-included 1 data [TAX1+]) associated with the next line number “2” (step P8 (Yes)), and the current line number “1” is increased by +1 and updated to “2” (step P9).

In this case, the calculation operation data registered in the calculation data memory 22c (see FIG. 3) in association with the current line number “2” is the tax-included 1 data [TAX1+] and determined not to be calculation operation data including the numerical value data and the tax-included (or tax-excluded) data (step P3 (No)). Further, since the same tax-included data is included in both the calculation operation data associated with the previous line number “1” and the calculation operation data associated with the current line number “2,” it is determined to be the consecutive same tax calculation data (step P5 (Yes)). In this case, printing on the recording sheet P is not performed (printing is suppressed) (step P6).

Thereafter, even when the current line number “2” is updated to “3” (step P8 (Yes) and step P9), the calculation data associated with the line number “3” continues Since it is determined to be the consecutive same tax calculation data (step P3 (No) and step P5 (Yes)), printing on the recording sheet P is not performed (printing is suppressed) (step P6).

Then, when the line number is updated to the current line number “4,” it is similarly determined to be the calculation operation data including the numerical value data “300” and the tax-included 2 data [TAX2+] (step P3 (Yes)), the numerical value data(tax-excluded amount data) “300·−T,” the tax rate data “8·% T,” the tax amount data “24·T,” and the tax-included amount data “324·+T” are printed on the recording sheet P through the printing unit 13 as the tax calculation result data according to the numerical value data “300” and the tax-included 2 data [TAX2+] (step P4).

Thereafter, when the line number is updated to the current line number “5,” the calculation data associated with the line number “5” is similarly determined to be the consecutive same tax calculation data (step P3 (No) and step P5 (Yes)), printing on the recording sheet P is not performed (printing is suppressed) (step P6).

Each time the line number is updated to the current line number “6,” “7,” or “8,” the corresponding numerical value data (tax-excluded amount data) “1500·−T,” “400·−T,” and “2000·−T,” the tax rate data “10·% T,” “8·% T,” and “10·% T,” the tax amount data “150·T,” “32·T,” and “200·T,” and the tax-included amount data “1650·+T,” “432·+T,” and “2200·+T” are printed on the recording sheet P through the printing unit 13 (steps P8 and P9→steps P3 and P4).

Then, when the line number is updated to the current line number “9,” the calculation operation data associated with the line number “9” is the total tax data [TAX TOTAL] and determined not to be the calculation operation data including the numerical value data and the tax-included (or tax-excluded) data (steps P8 and P9→step P3 (No)). Further, the (tax-included 1 data [TAX1+]) included in the calculation operation data associated with the previous line number “8” and the calculation operation data (total tax data [TAX TOTAL]) associated with the current line number “9” are determined not to be the same tax calculation data (step P5 (No)).

In this case, the tax-excluded amount data “4000·−T,” the tax amount data “400·T,” and the tax-included amount data “4400·+T” of the tax 1 subtotal, the tax-excluded amount data “700·−T,” the tax amount data “56·T,” and the tax-included amount data “756·+T” of the tax 2 subtotal, and the tax-excluded amount data “4700·−T,” the tax amount data “456·T,” and the tax-included amount data “5156·*” of the total are printed on the recording sheet P through the printing unit 13 as the result data of the total on the basis of the calculation operation data including each piece of numerical value data and the tax-included 1 data [TAX1+] or the tax-included 2 data [TAX2+] registered in the calculation data memory 22c (step P7 (similar to step S32)).

After that, when the line number is updated to the current line number “10,” “11,” . . . “16,” and “17” (step P8 (Yes) and step P9), the calculation data associated with each line number is determined to be the consecutive same tax calculation data (step P3 (No) and step P5 (Yes)), and printing on the recording sheet P is not performed (printing is suppressed) (step P6).

Accordingly, even after it returns to the line number data “0” and the numerical value data “0” displayed on the display unit 12 by the operation of the [CA] (Clear All) key 11f by the operation of [CA] (Clear All) key 11f, it is possible to easily print the tax-excluded amount data(−T), the tax rate data (% T), the tax amount data(T), and the tax-included amount data(+T) according to each tax rate, the tax-excluded amount data(−T), the tax amount data(T), the tax-included amount data(+T) of the subtotal according to each tax rate, and the tax-excluded amount data(−T), the tax amount data(T), and the tax-included amount data(+T) of the total on the recording sheet P by operating the [REPRINT] (registered data print) key 11g.

Therefore, in accordance with the printer-equipped calculator 10 having the above configuration, when the numerical value data of the tax-excluded amount of the normal taxable item (the tax rate 1) is input by operating the numeric keys, and the [tax-included 1] (tax 1 calculation) Key 11b1 is operated, the tax-included amount data of the normal taxable item is calculated and displayed. Further, when the numerical value data of the tax-excluded amount of the reduced taxable item (the tax rate 2) is input by operating the numeric keys, and the [tax-included 2] (tax 2 calculation) key 11b2 is operated, the tax-included amount data of the reduced taxable item is calculated and displayed. Then, when the [subtotal tax calculation] (total tax calculation) key 11d is operated, the total tax-included amount data obtained by adding the tax-included amount data of each tax rate is calculated and displayed. Thereafter, when the [REPRINT] key 11e is operated, the numerical value data (tax-excluded amount), the subtotal tax-excluded amount data, the subtotal tax amount data, and the subtotal tax-included amount data of each tax rate and the tax-excluded amount data, the tax amount data, and the tax-included amount data of the total are calculated and printed on the recording sheet P through the printing unit 13.

Accordingly, it is possible to perform the tax calculation in which a plurality of tax rates are mixed according to each tax rate and easily print it.

Further, according to the printer-equipped calculator 10 having the above configuration, if the [tax-included 1] (tax 1 calculation) key 11b1 or the [tax-included 2] (tax 2 calculation) key 11b2 is repeatedly operated after the total tax-included amount data is displayed by operating [subtotal tax calculation] (total tax calculation) key 11d, it is possible to switch and display the subtotal tax-included amount data, the subtotal tax-excluded amount data, and the subtotal tax amount data of each tax rate.

Further, in accordance with the printer-equipped calculator 10 having the above configuration, when the numerical value data of the tax-excluded amount of the normal taxable item (the tax rate 1) is input, the [tax-included 1] (tax 1 calculation) key 11b1 is operated, the numerical value data of the tax-excluded amount of the reduced taxable item (the tax rate 2) is input, and the [tax-included 2] (tax 2 calculation) key 11b2 is operated, the calculation operation data in which the tax-included 1 data [TAX1+] indicating the operation of the [tax-included 1] key 11b1 or the tax-included 2 data [TAX2+] indicating the operation of the [tax-included 2] key 11b2 is associated with the numerical value data in the input order of the numerical value data of the tax-excluded amount is registered in the calculation data memory 22c.

Then, if the [REPRINT] key 11e is operated after the total tax-included amount data is displayed by operating the [subtotal tax calculation] (total tax calculation) key 11d, it is possible to print the numerical value data(tax-excluded amount), the subtotal tax-excluded amount data, the subtotal tax amount data, and the subtotal tax-included amount data of each tax rate and the tax-excluded amount data, the tax amount data, and the tax-included amount data of the total on the recording sheet P through the printing unit 13 on the basis of each piece of calculation operation data registered in the calculation data memory 22c. Further, if the [CA] (Clear All) key 1 if is operated after the total tax-included amount data is displayed by operating the [subtotal tax calculation] (total tax calculation) key 11d, and the [REPRINT] key 11e is operated in a state in which the total tax-included amount data is not displayed, it is possible to print the tax-excluded amount data, the tax rate data, the tax amount data, and the tax-included amount data of each piece of numerical value data (tax-excluded amount), the subtotal tax-excluded amount data, the subtotal tax amount data, and the subtotal tax-included amount data of each tax rate, and the tax-excluded amount data, the tax amount data, and the tax-included amount data of the total on the recording sheet P through the printing unit 13 on the basis of each piece of calculation operation data registered in the calculation data memory 22c.

Further, when the printer-equipped calculator 10 according to the above embodiments is configured not to include the calculation data memory 22c due to a memory capacity limitation, the calculation of the tax-included amount data, the tax amount data, and the tax-excluded amount data corresponding to the tax 1 (tax 2), the calculation of the tax-included amount data, the tax amount data, and the tax-excluded amount data corresponding to the tax 1 subtotal (tax 2 subtotal), and the calculation of the tax-included amount data, the tax amount data, and the tax-excluded amount data corresponding to the total are performed on the basis of the tax calculation data registered in the tax calculation data memory 22e.

In the above embodiments, the example in which, after the numerical value data which is the tax-excluded amount data of each item price such as the normal taxable item or the reduced taxable item is input, the tax-included amount data of each item price is first calculated and displayed by operating the [tax-included 1] (tax-included 1 calculation) key 11b1 or the [tax-included 2] (tax-included 2 calculation) key 11b2, and then a series of tax calculation processes are performed has been described.

On the other hand, when, after the numerical value data which is the tax-included amount data of each item price, the tax-excluded amount data of each item price is first calculated and displayed by operating the [tax-excluded 1] (tax-excluded 1 calculation) key 11c1 or the [tax-excluded 2] (tax-excluded 2 calculation) key 11c2, and then a series of tax calculation processes are performed, since it is a similar process if the “tax-excluded 1”[TAX1+] or the “tax-excluded 2” [TAX2+]″ and tax-excluded 1” [TAX1−] or the “tax-excluded 2” [TAX2−] are reversely handled, detailed description thereof is omitted.

Each technique of each of the processes performed by the printer-equipped calculator 10 described in each of the above embodiments, that is, the technique of each of the calculation data printing process illustrated in the flowcharts of FIGS. 5 to 7, the registered data printing processes illustrated in the flowcharts of FIGS. 8 and 9, and the like may be stored in a medium of an external recording device such as a memory card (a ROM card, a RAM card, or the like), a magnetic disk (a floppy (a registered trademark) disk, a hard disk, or the like), an optical disk (a CD-ROM, a DVD, or the like), a semiconductor memory as a program executable by a computer and distributed. Further, a computer (CPU) of an electronic calculator with a print function is able to implement the calculation data print function described in each of the above embodiments and perform a process similar to the process performed by the above-described technique by reading the program recorded in the medium of the external recording device into a storage device and controls an operation according to the read program.

Further, it is possible to transmit data of the program for implementing each of the above-described technique on a communication network (N) as a form of a program code, and it is possible to fetch the data of the program from a computer device (a program server) connected to the communication network (N) into an electronic calculator with a print function, cause the data to be stored in a storage device, and implement the calculation data print function.

The present invention is not limited to the above embodiments, and various modifications can be made within the scope not departing from the gist thereof. Further, inventions at various stages are included in the above embodiments, and various inventions can be extracted by appropriately combining a plurality of disclosed constitutional elements. For example, although some constitutional elements are deleted from all constitutional elements described in each embodiment, or some constituent elements are combined in a different form, if it is possible to solve the problems described in the section “problems to be solved by the invention,” and the effect described in the section “effects of the invention” is obtained, the configuration in which the constitutional elements are deleted or combined can be extracted as the invention.

What is claimed is:

1. A calculating device, comprising:
a display; and
a processor,
wherein, when numerical value data of tax-excluded amount data is input in accordance with a user operation, and a first operation for a tax calculation of a first tax rate is received, the processor calculates first tax-included amount data according to the first tax rate for the numerical value data,
when numerical value data of tax-excluded amount data is input in accordance with the user operation, and a second operation for a tax calculation of a second tax rate is received, the processor calculates second tax-included amount data corresponding to the second tax rate for the numerical value data,
when a third operation for a total tax calculation is received from a user, the processor causes total tax-included amount data to be displayed on the display, the total tax-included amount data being obtained by adding first subtotal tax-included amount data and second subtotal tax-included amount data obtained by adding at least one piece of the second tax-included amount data,
wherein, the first subtotal tax-included amount data is a data that obtained by adding at least one piece of the calculated first tax-included amount data, and the second subtotal tax-included amount data is a data that obtained by adding at least one piece of the second tax-included amount data, and
when a fourth operation for printing is received from the user after the total tax-included amount data is displayed on the display, the processor causes a printer to print subtotal tax-excluded amount data of the first tax rate corresponding to the first tax-included amount data and subtotal tax-excluded amount data of the second tax rate corresponding to the second tax-included amount data.

2. The calculating device according to claim 1,
wherein the processor causes the printer to further print the displayed total tax-included amount data on the display.

3. The calculating device according to claim 1,
wherein the processor causes the printer to further print subtotal tax amount data of the first tax rate corresponding to the first tax-included amount data and subtotal tax amount data of the second tax rate corresponding to the second tax-included amount data.

4. The calculating device according to claim 1,
wherein the processor causes the printer to print each piece of numerical value data input in accordance with the user operation.

5. The calculating device according to claim 1,
wherein the processor causes subtotal tax-included amount data of the tax calculation of the first tax rate or subtotal tax-excluded amount data of the first tax rate and subtotal tax amount data of the first tax rate to be sequentially displayed each time the first operation is received after the total tax-included amount data is displayed on the display.

6. The calculating device according to claim 1,
wherein the processor causes total tax-excluded amount data and total tax amount data to be sequentially displayed on the display each time the third operation is received after the total tax-included amount data is displayed on the display, the total tax-excluded amount data being obtained by adding subtotal tax-excluded amount data of the first tax rate and subtotal tax-excluded amount data of the second tax rate, the total tax amount data being obtained by adding subtotal tax amount data of the first tax rate and subtotal tax amount data of the second tax rate.

7. The calculating device according to claim 1,
wherein the processor sets a print mode or a non-print mode in accordance with the user operation, and
when the print mode is set,
every time the numerical value data is input, and the first operation is received, the processor causes the printer to sequentially print tax calculation result data of the first tax rate including the tax-excluded amount data which is the numerical value data and the first tax-included amount data obtained by performing a calculation on the numerical value data in accordance with the first tax rate, and
each time the numerical value data is input, and the second operation is received, the processor causes the printer to sequentially print tax calculation result data of the second tax rate including the tax-excluded amount data which is the numerical value data and the second tax-included amount data obtained by performing a calculation on the numerical value data in accordance with the second tax rate.

8. The calculating device according to claim 1,
wherein the processor registers the input numerical value data and tax calculation data corresponding to the received operation for the tax calculation as calculation operation data.

9. The calculating device according to claim 8,
wherein on the basis of the registered calculation operation data, the processor causes the printer to print the tax-excluded amount data of the first tax rate or the second tax rate corresponding to the input numerical value data, the subtotal tax-excluded amount data of the first tax rate or the second tax rate, the subtotal tax amount data of the first tax rate or the second tax rate, and the subtotal tax-included amount data of the first tax rate or the second tax rate and causes the printer to print total tax-excluded amount data, total tax amount data, and total tax-included amount data obtained by adding the subtotal tax-excluded amount data, the subtotal tax amount data, and the subtotal tax-included amount data of the first tax rate or the second tax rate.

10. The calculating device according to claim 9,
wherein the processor causes the printer to print when the fourth operation for the printing is received in a state in which the total tax-included amount data is displayed on the display.

11. The calculating device according to claim 8,
wherein the processor causes the printer to print the tax-excluded amount data, the tax amount data, and the tax-included amount data of the first tax rate or the second tax rate corresponding to the input numerical value data, the subtotal tax-excluded amount data, the subtotal tax amount data, and the subtotal tax-included amount data of each tax rate obtained by adding the tax-excluded amount data, the tax amount data, and the tax-included amount data of the first tax rate or the second tax rate according to the first tax rate and the second tax rate, and the total tax-excluded amount data, the total tax amount data, and the total tax-included amount data obtained by adding the subtotal tax-excluded amount data, the subtotal tax amount data, and the subtotal tax-included amount data of each tax rate on the basis of the calculation operation data in a registration order of the registered calculation operation data.

12. The calculating device according to claim 11,
wherein the processor causes the printer to print when the fourth operation for the printing is received in a state in which the total tax-included amount data is displayed on the display and erased.

13. The calculating device according to claim 1, further comprising,
the printer.

14. A method of controlling a calculating device, comprising:
calculating, when numerical value data of tax-excluded amount data is input in accordance with a user operation, and an operation for a tax calculation of a first tax rate is received, first tax-included amount data according to the first tax rate for the numerical value data,
calculating, when numerical value data of tax-excluded amount data is input in accordance with the user operation, and an operation for a tax calculation of a second tax rate is received, second tax-included amount data corresponding to the second tax rate for the numerical value data,
causing total tax-included amount data to be displayed when an operation for a total tax calculation is received from a user, the total tax-included amount data being obtained by adding first subtotal tax-included amount data obtained by adding at least one piece of the calculated first tax-included amount data and second subtotal tax-included amount data obtained by adding at least one piece of the second tax-included amount data, and
causing, when an operation for printing is received from the user after the total tax-included amount data is displayed, a printer to print subtotal tax-excluded amount data of the first tax rate corresponding to the first tax-included amount data and subtotal tax-excluded amount data of the second tax rate corresponding to the second tax-included amount data.

15. A computer-readable recording medium having a program recorded therein, the program causing a device to execute when executed:
calculating, when numerical value data of tax-excluded amount data is input in accordance with a user operation, and an operation for a tax calculation of a first tax rate is received, first tax-included amount data according to the first tax rate for the numerical value data,
calculating, when numerical value data of tax-excluded amount data is input in accordance with the user operation, and an operation for a tax calculation of a second tax rate is received, second tax-included amount data corresponding to the second tax rate for the numerical value data,
causing total tax-included amount data to be displayed when an operation for a total tax calculation is received from a user, the total tax-included amount data being obtained by adding first subtotal tax-included amount data obtained by adding at least one piece of the calculated first tax-included amount data and second subtotal tax-included amount data obtained by adding at least one piece of the second tax-included amount data, and
causing, when an operation for printing is received from the user after the total tax-included amount data is displayed, a printer to print subtotal tax-excluded amount data of the first tax rate corresponding to the first tax-included amount data and subtotal tax-excluded amount data of the second tax rate corresponding to the second tax-included amount data.
